(19) United States
(12) Patent Application Publication
(10) Pub. No.: US 2020/0180056 A1
(43) Pub. Date: Jun. 11, 2020

(54) THREADED CUTTER FOR THE PRODUCTION OF A THREAD

(71) Applicant: Vargus Ltd., Nahariya (IL)

(72) Inventor: Winfried HOLSCHER, Engen (DE)

(21) Appl. No.: 16/492,435

(22) PCT Filed: Mar. 9, 2018
(86) PCT No.: PCT/EP2018/055874

§ 371 Date: Dec. 2, 2019

(30) Foreign Application Priority Data
Mar. 9, 2017 (DE) 10 2017 105 018.3

(51) Int. Cl. B23G 5/18

(52) U.S. Cl. CPC B23G 5/18

(57) ABSTRACT

The invention relates to a thread milling cutter for manufacturing an internal thread, wherein the thread milling cutter has at least one section with multiple teeth, wherein a pitch is arranged between every two adjacent teeth, wherein the predominant number of pitches corresponds to a desired pitch and there is at least one pitch that deviates from the desired pitch.

The invention further relates to a method for manufacturing an external thread on a component or an internal thread in a component, wherein, in one step, a thread milling cutter according to the invention is advanced into the wall of the component and in another step, the thread milling cutter is moved along the extent of the wall once and in this way is moved in the axial direction by one lead of a thread turn.

### CROSS-REFERENCE TO RELATED APPLICATIONS

This application is a Section 371 US national phase application of International Patent Application No. PCT/EP2018/055874, filed Mar. 9, 2018, which was published in the German language on Sep. 13, 2018 under International Patent Application Publication No. WO 2018/162697 A1, which claims priority under 35 U.S.C. § 119(b) to German Patent Application No. 10 2017 105 018.3, which was filed Mar. 9, 2017, the entirety of the aforementioned applications are incorporated herein by reference in their entirety.

### BACKGROUND OF THE INVENTION

The invention relates to a thread milling cutter or thread miller and a method for producing or manufacturing a thread according to the preamble of claim 1 and also to a method for manufacturing the thread.

One known problem is that threaded connections can loosen, especially in the event of vibrations.

It is already known to provide additional securing means, for example, locking washers, to prevent loosening of the threaded connection. Additional securing means, however, require cost and effort in manufacturing and handling.

DE 10 2015 000 236 B4 discloses a method for manufacturing an all-metal locking nut for threaded connections, in which one half of the thread turn is formed on each of the opposite sides of the nut, wherein one half of the thread turn is offset axially by the size of the thread backlash relative to the rest of the thread turn. Such an offset of a part of the thread turns causes a braking torque and acts against a loosening of the closed threaded connection. The method for manufacturing such an internal thread, however, has the disadvantage that a part of the thread must be inserted into the body from both sides of the body, which makes the method complicated.

The problem of the invention is to disclose a possibility of being able to manufacture a thread that secures against loosening in a simple way.

### BRIEF SUMMARY OF THE INVENTION

The problem described above is solved by a thread milling cutter of the preferred invention for manufacturing a thread with the features of claim 1 and also by a method for manufacturing a thread with the features of claim 9.

Advantageous constructions and refinements of the invention are specified in the dependent claims.

The thread milling cutter according to the invention for manufacturing a thread has at least one section with multiple teeth, wherein a pitch is arranged between every two adjacent teeth, and is distinguished in that the predominant number of pitches corresponds to a desired pitch and there is at least one first pitch that deviates from the desired pitch. The teeth are typically all formed with an identical shape. The pitch of the teeth can be considered to be, for example, the distance between the crests of two adjacent teeth.

In conventional thread millers or thread milling cutters, all the teeth are arranged equidistant to each other. In the thread milling cutter according to the invention, such an arrangement is interrupted at least for pairs of adjacent teeth that are arranged at a first pitch relative to each other that deviates from the desired pitch. According to the invention, it is provided that the thread milling cutter has at least two sections with multiple teeth that are arranged so that they can be adjusted, preferably moved, relative to each other in the axial direction. This makes it possible to be able to adjust the pitch deviating from the desired pitch as a function of the use case.

If such a thread milling cutter is used for manufacturing a thread, without additional processing of the thread, a thread is realized with a braking torque that causes a securing of the threaded connection against loosening, for example, in the event of vibrations.

The first pitch can be constructed smaller than or greater than the desired pitch. Advantageously, the at least one first pitch is constructed smaller than the desired pitch, which can therefore achieve a good braking torque.

Advantageously, the first pitch is arranged in the area of the first ten teeth, counted starting from the free end of the thread milling cutter.

Advantageously, at least the first two pitches, preferably at least the first three or four pitches, counted starting from the free end of the thread milling cutter, correspond to the desired pitch. This has the effect that the threaded connection can be initially screwed in a few thread turns without resistance and part of the the thread turn generating the braking torque engages only after a few turns. Preferably, the first pitch is arranged between the fourth and the fifth tooth, counted starting from the free end of the thread milling cutter.

Advantageously, the deviation of the first pitch from the desired pitch is approximately in the range from 2% to 20%, preferably approximately in the range from 5% to 15%, of the desired pitch. In this way, a good braking effect is achieved. The optimum deviation can be dependent on the materials. For example, for harder materials, a smaller deviation can be sufficient than for softer materials, in order to achieve the same braking effect.

Advantageously, the deviation of the first pitch from the desired pitch is approximately in the range of the thread backlash. This enables a good braking effect and also allows the threaded connection to be screwed in further.

Advantageously, a section with multiple teeth is arranged on a first milling cutter part and a section with multiple teeth is arranged on a second milling cutter part, wherein the two milling cutter parts can be fixed relative to each other at different pitches. This makes it possible to adjust the braking moment in a simple way.

In an especially preferred way, a spacer is arranged between the two milling cutter parts. The spacer makes it possible in a simple way to fix the pitch of the two milling cutter parts relative to each other. The pitch can be easily varied through spacers of different thicknesses.

Preferably, at least one of the two milling cutter parts can be placed on a shaft. This enables a structurally simple construction.

Advantageously, one or more recesses running in the axial direction are arranged on one of the two milling cutter parts, wherein a projection, which is arranged on the other of the two milling cutter parts and extends, in particular, in the axial direction, engages in these recesses, which makes it possible to provide rotational locking means between the two milling cutter parts in a simple way.

In the method according to the preferred invention for manufacturing an external thread with means that secure against loosening, on a component or an internal thread with means that secure against loosening in a component, in one step, a thread milling cutter according to the invention is advanced into the wall of the component and in another step, the thread milling cutter is moved along the extent of the wall once and in this way is moved in the axial direction by one lead of a thread turn.

By means of such a method it is possible to manufacture the entire thread in the component by milling with a thread milling cutter and a single guide along the extent of the wall in a helical line, wherein this thread already includes a braking torque due to the thread milling cutter being formed according to the invention, because one of the thread turns of the thread manufactured in this way has a deviating, for example, reduced lead and thus a braking effect is achieved.

For the method according to the invention for manufacturing an external thread with means that secure against loosening on a component, in a first step, a component with a diameter that corresponds to the outer diameter of the external thread to be manufactured is provided; in a second step, a thread milling cutter according to the invention is moved onto the component and is aligned with its longitudinal axis parallel to the longitudinal axis of the external thread to be milled; in a third step, the thread milling cutter is advanced in the radial direction into the wall of the component and in a fourth step, the thread milling cutter is moved along the extent of the wall once and in this way is moved in the axial direction by one lead of a thread turn.

For the method according to the invention for manufacturing an internal thread with means that secure against loosening in a component, in a first step, a component with a hole with a diameter that corresponds to the core diameter of the internal thread to be milled is provided; in a second step, a thread milling cutter according to the invention is inserted into the hole and aligned with its longitudinal axis parallel to the longitudinal axis of the internal thread to be milled; in a third step, the thread milling cutter is advanced in the radial direction into the wall of the component, in particular the wall of the hole, and in a fourth step, the thread milling cutter is moved along the extent of the wall once and in this way is moved in the axial direction by one lead of a thread turn.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1 shows a detail from an axial section through an embodiment of a thread milling cutter according to the invention,

FIG. 2a shows a see-through side view of another embodiment of a thread milling cutter according to the invention,

FIG. 2b is an exploded-view diagram of FIG. 2a without the two milling cutter parts,

FIG. 2c is a top view of FIG. 2a,

FIG. 2d shows an axial section through another embodiment of a thread milling cutter according to the invention,

FIG. 3a shows a see-through side view of a retaining element for milling plates for another embodiment of a thread milling cutter,

FIG. 3b is a top view of FIG. 3a,

FIG. 4 is a partially sectioned view through an exploded-view diagram of another embodiment of a thread milling cutter, and

FIG. 5 is a partially sectioned view through rotational locking means between two milling cutter parts of a thread milling cutter.

### DETAILED DESCRIPTION OF THE INVENTION

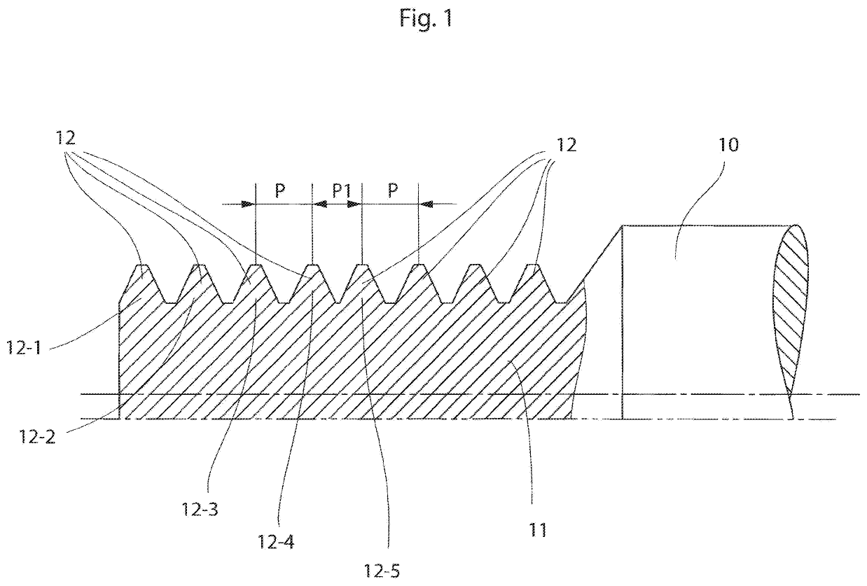

FIG. 1 shows a detail from an axial section through an embodiment of a thread milling cutter or thread miller 10. The thread milling cutter 10 has a shaft 11, on which multiple teeth 12 are arranged at least across an axial section and at least across a radial section. A portion of the teeth 12 can here be arranged in one piece on the shaft 11. A portion of the teeth 12 could also be arranged on a plate that is mounted on the shaft 11 of the thread milling cutter 10. According to one embodiment, two or more plates that can be mounted on the shaft 11 could also be provided, wherein each of the plates has multiple teeth 12 and the plates can be adjusted, for example, moved in the axial direction along the shaft 11 relative to each other and thus can be fixed in different relative positions to each other on the shaft 11.

Between every two adjacent teeth 12 there is a pitch, wherein the predominant number of pitches corresponds to a desired pitch P, but, according to the invention, there is at least one first pitch P1 that deviates from the desired pitch P.

In the present embodiment, the first pitch P1 is constructed smaller than the desired pitch P.

One embodiment of the invention provides that the first pitch P1 is arranged in the area of the first ten teeth 12, in particular, in the area of the first eight teeth 12, in the present embodiment, between the fourth tooth 12-4 and the fifth tooth 12-5, where counting starts from the free of the thread milling cutter 10, i.e., in particular, the end of the shaft 11 that is not fixed, and thus, for example, the first tooth 12-1 is arranged adjacent to the free end of the thread milling cutter 10, the second tooth 12-2 is arranged adjacent to the first tooth 12-1, and the third tooth 12-3 is arranged adjacent to the second tooth 12-2.

At least the first two pitches, preferably at least the first three or four pitches, in the present embodiment, the first three pitches, counted starting from the free end of the thread milling cutter, correspond to the desired pitch P.

The deviation of the first pitch P1 from the desired pitch P can be approximately in the range from 2% to 20%, in particular, in the range from 5% to 15%, of the desired pitch P. Here, the deviation that is optimal for a certain use case can be dependent on the material. For example, for a softer material such as aluminum, the deviation can be approximately in the range from 10% to 15%, while the deviation for a harder material such as steel can be, for example, approximately in the range from 5% to 10%.

In one preferred embodiment, the deviation of the first pitch P1 from the desired pitch P is in the range of the thread backlash.

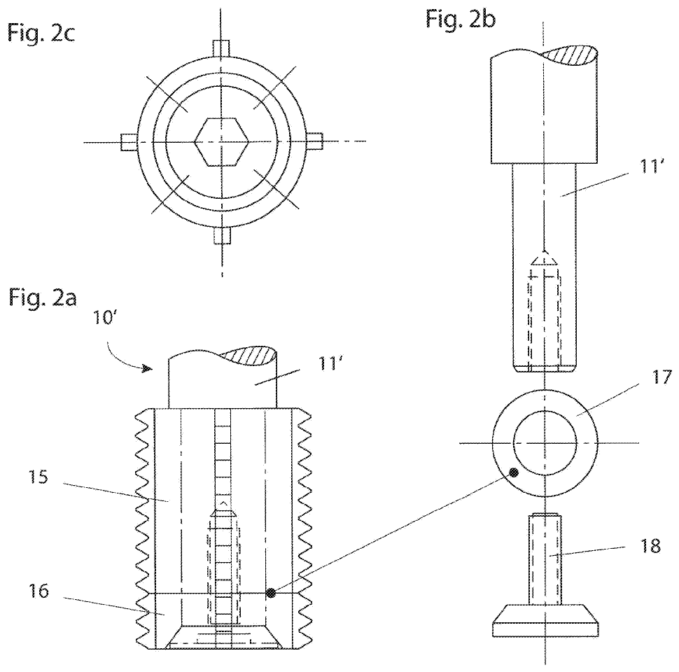

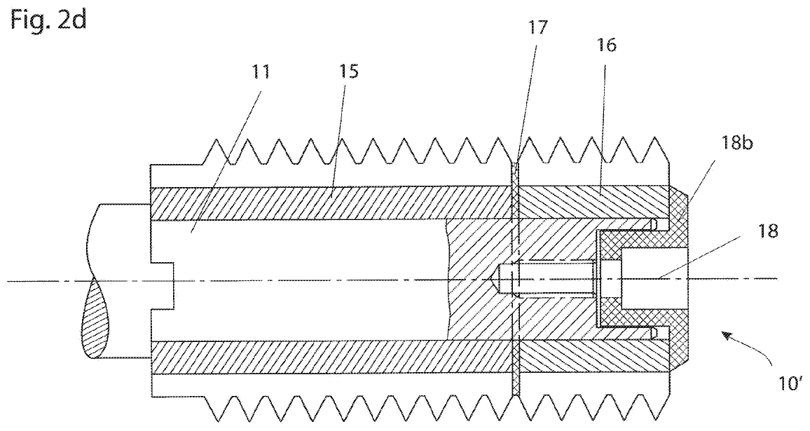

FIGS. 2a to 2c show another embodiment of a thread milling cutter 10′ that differs from the embodiment shown in FIG. 1 essentially in that the teeth 12 are arranged on a first milling cutter part 15 and a second milling cutter part 16, wherein both parts can be placed on a shaft 11′ independently from each other. The pitch between the milling cutter parts 15, 16, which defines the first pitch P1 between the adjacent teeth 12 arranged on the first milling cutter 15 and the second milling cutter 16, in this example, the teeth 12-3 and 12-4, can be defined by a spacer 18 that is placed between the milling cutter parts 15, 16 on the shaft 11′, wherein the pitch P1 can be varied by varying the thickness of the spacer 18.

The embodiment shown in FIG. 2d differs from the embodiment shown in FIGS. 2a to 2c merely in that the retaining screw 18 is inserted into a clamping sleeve 18b inserted into the second milling cutter part 16.

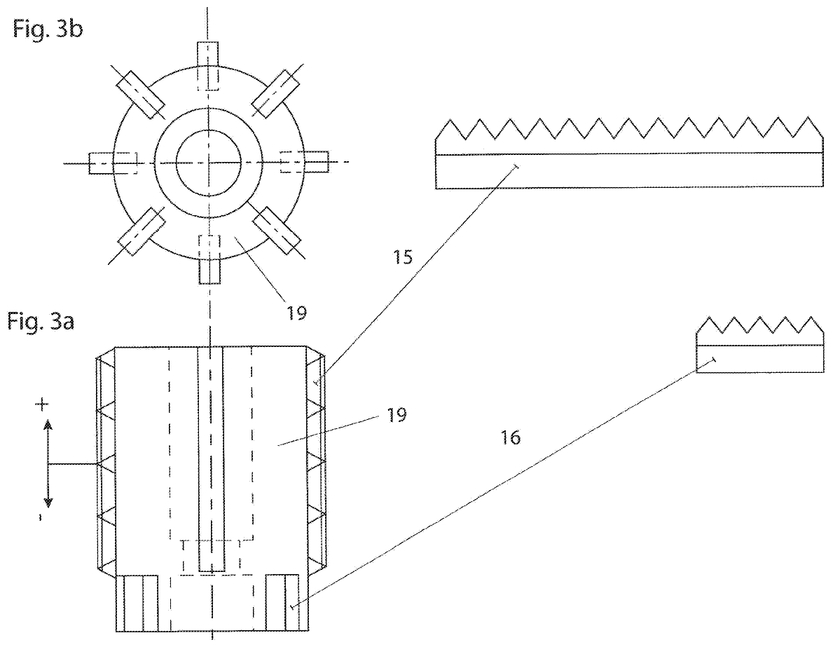

FIGS. 3a and 3b show another embodiment that differs from the embodiment shown in FIG. 1 in that the first milling cutter part 15 can be arranged on a retaining element 19 so that it can be adjusted, while the teeth of the second milling cutter part are arranged, for example, in one piece, on the retaining element 19. The retaining element 19 is placed on the shaft 11′.

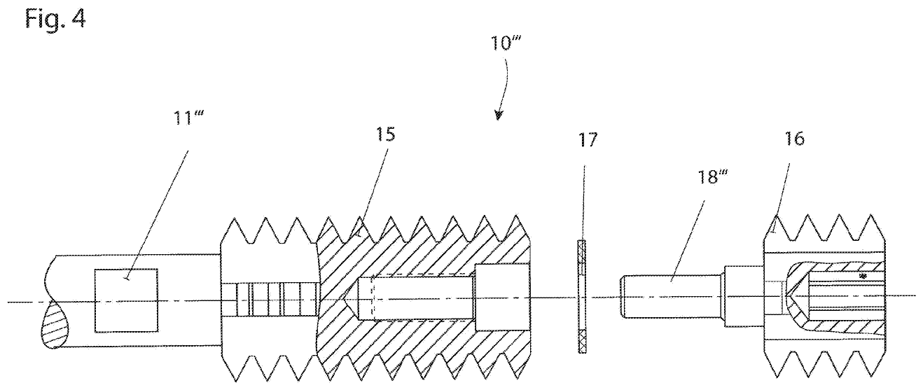

FIG. 4 shows another embodiment of a thread milling cutter 10′″ that differs from the embodiment shown in FIG. 1 in that the teeth of the first milling cutter part 15 are arranged in one piece on a shaft 11′″, wherein a threaded hole is arranged on the shaft 11′, in which a retaining screw 18′ arranged on the second milling cutter part 16 can be screwed in, so that the second milling cutter part 16 is arranged on the end face on the shaft 11′″. For this purpose, a recess for inserting a screw-driving instrument, for example, a screwdriver, a torx wrench, or a similar tool, can be arranged in the end face of the second milling cutter part 16 facing away from the retaining screw 18′. The pitch between adjacent teeth 12 arranged on the first milling cutter part 15 and the second milling cutter part 16 can be defined by means of the spacer 17 as in the first embodiment.

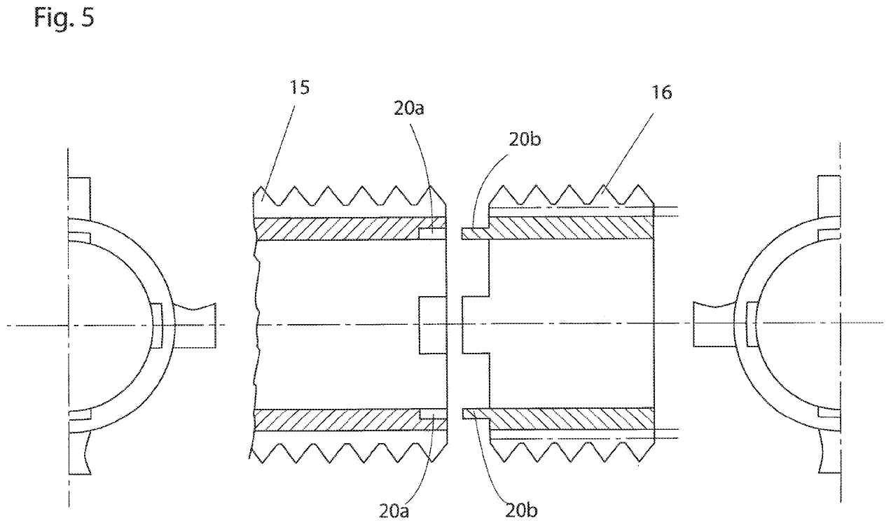

In order to provide rotational locking means between the first milling cutter part 15 and the second milling cutter part 16 of each of the previously mentioned embodiments, one or more recesses 20a running in the axial direction are arranged on one of the two milling cutter parts 15, 16, for example, on the first milling cutter part 15, wherein a projection 20b, which is arranged on the other of the two milling cutter parts 15, 16, for example, on the second milling cutter part 16, and extends, in particular, in the axial direction, engages in these recesses (see FIG. 5).

The thread milling cutter 10, 10′, 10′″ is used in the following for manufacturing an external thread on a component or an internal thread in a component. In one step, the thread milling cutter 10, 10′, 10′″ is advanced into the wall of the component and in another step, it is moved along the extent of the wall once and in this way, it is moved in the axial direction by one lead of a thread turn. In this way, merely by moving along one helical line with one winding, the entire thread can be provided in the wall, wherein the thread is also constructed without additional rework such that it has a braking effect.

If, for example, an external thread is to be manufactured on a component, in a first step, a component with a diameter that corresponds to the outer diameter of the external thread to be manufactured can be provided. Then, in a second step, the thread milling cutter 10, 10′, 10′″ can be moved onto the component and aligned with its longitudinal axis parallel to the longitudinal axis of the external thread to be milled. In a third step, the thread milling cutter 10, 10′, 10′″ can be advanced in the radial direction into the wall of the component, so that, in particular, for subsequent rotation of the thread milling cutter 10, 10′, 10′″ about its own longitudinal axis, it can begin to mill the external thread at this position of the wall. In a fourth step, the thread milling cutter can be moved, in particular, with the simultaneous rotation of the thread milling cutter 10, 10′, 10′″ about its own longitudinal axis, along the extent of the wall once and, in this way, can be moved in the axial direction by one lead of a thread turn.

If, for example, an internal thread is to be manufactured in a hole, initially, in a first step, a component with a hole with a diameter that corresponds to the core diameter of the internal thread to be manufactured can be provided. In a second step, the thread milling cutter 10, 10′, 10′″ can be inserted into the hole, in particular, far enough that the entire length of the internal thread to be manufactured overlaps the inserted length of the thread milling cutter 10, 10′, 10′″, and with its longitudinal axis aligned parallel to the longitudinal axis of the internal thread to be milled. In a third step, the thread milling cutter 10, 10′, 10′″ can be advanced in the radial direction into the wall of the hole, so that, in particular, for subsequent rotation of the thread milling cutter 10, 10′, 10′″ about its own longitudinal axis with the help of the teeth 12 of the thread milling cutter 10, it can begin to mill the internal thread at this position in the wall of the hole. In a fourth step, the thread milling cutter 10, 10′, 10′″ can be moved, in particular, with simultaneous rotation of the thread milling cutter 10, 10′, 10′″ about its own longitudinal axis, along the extent of the wall of the hole once and, in this way, it can be moved in the axial direction by one lead of a thread turn.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

10, 10′, 10′″ Thread milling cutter
11, 11′, 11′″ Shaft
12 Tooth
12-1 First tooth
12-2 Second tooth
12-3 Third tooth
12-4 Fourth tooth
12-5 Fifth tooth
15 Milling cutter part
16 Milling cutter part
17 Spacer
18, 18′″ Retaining screw
18b Clamping sleeve
19 Retaining element
20a Recess
20b Projection
P Desired pitch
P1 First pitch

1-16. (canceled)

17. A thread milling cutter for manufacturing a thread, the thread milling cutter comprising: at least one section with multiple teeth, wherein there are thread pitches between every two adjacent ones of the multiple teeth, wherein a predominant number of the thread pitches corresponds to a desired pitch, at least one first pitch of the thread pitches deviates from the desired pitch, wherein the thread milling cutter has at least one section with multiple teeth and a second section with multiple teeth that are arranged so that the at least one section and the second section are offset axially relative to each other.

18. The thread milling cutter according to claim 17, wherein the at least one first pitch is constructed smaller than the desired pitch.

19. The thread milling cutter according to claim 17, wherein the at least one first pitch is arranged in an area of a first ten teeth of the multiple teeth, counted starting from a free end of the thread milling cutter.

20. The thread milling cutter according to claim 17, wherein at least a first two pitches of the thread pitches, preferably at least one of a first three pitches and a first four pitches of the thread pitches, counted starting from a free end of the thread milling cutter, correspond to the desired pitch.

21. The thread milling cutter according to claim 17, wherein a first pitch of the thread pitches is arranged between a fourth tooth and a fifth tooth of the multiple teeth, counted starting from a free end of the thread milling cutter.

22. The thread milling cutter according to claim 17, wherein a deviation of the at least one first pitch from the desired pitch is approximately in a range from 2% to 20%.

23. The thread milling cutter according to claim 17, wherein a deviation of a first pitch from the desired pitch is approximately in a range of a thread backlash.

24. The thread milling cutter according to claim 17, wherein the thread milling cutter is configured for manufacturing an external thread with means that secure against loosening on a component or an internal thread with means that secure against loosening in the component, in a first step, the thread milling cutter is advanced into a wall of the component and in another step, the thread milling cutter is moved along an extent of the wall once and in this way is moved in an axial direction by a lead of a thread turn.

25. The thread milling cutter according to claim 17, wherein the thread milling cutter is configured for manufacturing an external thread with means that secure against loosening on a component, wherein, in a first step, a component is provided with a diameter that corresponds to an outer diameter of an external thread to be manufactured, and wherein, in a second step, the thread milling cutter is moved onto the component and is oriented with a longitudinal axis of the thread milling cutter parallel to a longitudinal axis of the external thread to be milled, in a third step the thread milling cutter is advanced in a radial direction into a wall of the component, and in a fourth step, the thread milling cutter is moved along an extent of the wall once and in this way is moved in an axial direction by one lead of a thread turn.

26. The thread milling cutter according to claim 17, wherein the thread milling cutter is configured for manufacturing an internal thread in a component, wherein, in a first step, a component with a hole with a diameter that corresponds to a core diameter of the internal thread to be manufactured is provided, and wherein, in a second step, a thread milling cutter is moved into the hole and is oriented with a longitudinal axis of the thread milling cutter parallel to a longitudinal axis of the internal thread to be milled, in a third step, the thread milling cutter is advanced in a radial direction into a wall of the hole, and in a fourth step, the thread milling cutter is moved along an extent of the wall once and in this way is moved in an axial direction by one lead of a thread turn.

27. The thread milling cutter according to claim 22, wherein the range is approximately 5% to 15% of the desired pitch.

28. The thread milling cutter of claim 17, wherein the at least one section with multiple teeth is arranged on a first milling cutter part and the second section with multiple teeth is arranged on a second milling cutter part, wherein the first and second milling cutter parts can be fixed relative to each other at different pitches.

29. The thread milling cutter of claim 28, wherein a spacer is arranged between the first and second milling cutter parts.

30. The thread milling cutter of claim 28, wherein at least one of the first and second milling cutter parts can be placed onto a shaft.

31. The thread milling cutter of claim 28, wherein one or more recesses run in an axial direction and are arranged on one of the first and second milling cutter parts, wherein a projection, which is arranged on the other of the one of the first and second milling parts, extends in an axial direction and engages in the one or more recesses.
